(19) United States
(12) Patent Application Publication
(10) Pub. No.: US 2026/0022060 A1
(43) Pub. Date: Jan. 22, 2026

(54) Glass or glass-ceramic product, process for production thereof and ink

(71) Applicant: SCHOTT AG, Mainz (DE)

(72) Inventors: Annika Boese, Mainz (DE); Angelina Milanovska, Mainz (DE); Carmen Martens, Mainz (DE)

(21) Appl. No.: 19/266,254

(22) Filed: Jul. 11, 2025

(30) Foreign Application Priority Data
Jul. 17, 2024 (DE) 102024120239.4
Jan. 31, 2025 (DE) 202025100493.3

(51) Int. Cl. C03C 17/00; C03C 10/00; C09D 11/03

(52) U.S. Cl. CPC C03C 17/007; C03C 10/0027; C03C 17/002; C09D 11/03; C03C 2217/475; C03C 2218/119

(57) ABSTRACT

A glass or glass-ceramic product having a substrate made of a glass or glass-ceramic, wherein the substrate has been provided with an essentially pigment-free coating at least on one side over at least a part of its surface, wherein the coating includes an at least partly fused glass flux, wherein the surface of the coating has a mean square height Sq of at least 0.1 μm and at most 2.5 μm, and wherein the coating has a core height Sk of at least 1.0 μm to at most 10 μm. A method and an ink for production of the glass or glass-ceramic product is also provided.

This claims priority to German patent applications DE 10 2024 120 239.4, filed on Jul. 17, 2024 and DE 20 2025 100 493.3, filed on Jan. 31, 2025, all of which are hereby incorporated by reference herein.

The invention relates to a glass or glass-ceramic product having a coating, to a method of producing such a glass-ceramic product and to an ink for production of the glass or glass-ceramic product.

### BACKGROUND

The prior art discloses a variety of applications for glass and glass-ceramic products. Especially in the case of glass-ceramic products in pane form, probably the most prominent example of application is use as a cooking surface.

Glass-ceramic cooking surfaces are frequently equipped with functional coatings on the top side that fulfil different functions. The prior art includes, for example, coatings known from EP 2 964 854 B1 that protect such a glass-ceramic cooking surface from scratches by means of a layer of AlSiN deposited on the substrate. In addition, there are also known coatings that are intended to prevent soiling of cooking surfaces, in particular by fingerprints. One example that could be cited here would be WO 2023/099833 A1.

In the recent past, there have also been attempts to prevent both scratches on the surface of a substrate and the formation of fingerprints or generally soiling of the cooking surface. One example that could be cited here would in turn be EP 4 077 231 A1. This discloses a glass-ceramic article obtained by a method comprising a heat treatment for ceramization of a glass suitable for forming a glass-ceramic and a chemical treatment of a surface of the glass before and/or after the heat treatment for ceramization, wherein the chemical surface treatment is performed in such a way that, after heat treatment, the arithmetic average roughness of the surface is between 2 μm and 7 μm. In particular, the use of an acid solution based on hydrofluoric acid is described with regard to the chemical treatment of the surface.

### SUMMARY OF THE INVENTION

The use of hydrofluoric acid is indeed already known for etching of glass and glass-ceramic, but it brings a number of drawbacks. Firstly, the time required to etch a glass or glass-ceramic until the roughness mentioned above has been established is comparatively high. Secondly, hydrofluoric acid is a very problematic substance in terms of handling, for which a multitude of safety measures have to be taken in order to ensure both protection of the environment and the protection of those working with hydrofluoric acid.

Against this background, there is a need in the prior art for a solution by means of which a glass or glass-ceramic article having a surface that is both resistant to scratches and largely prevents the formation of fingerprints and other soiling can be provided with minimum complexity, both in terms of time demands and occupational safety.

The present invention provides a glass or glass-ceramic product, and a corresponding production process and an ink to be used therein.

In a first aspect, the invention relates to a glass or glass-ceramic product having a substrate made of a glass or glass-ceramic, wherein the substrate has been provided with an essentially pigment-free coating at least on one side over at least a part of its surface, wherein the coating includes an at least partly fused, preferably boron-containing, glass flux, wherein the surface of the coating has a mean square height Sq of at least 0.1 μm and at most 2.5 μm, and wherein the coating has a core height Sk of at least 1.0 μm to at most 10 μm.

The expression “essentially pigment-free” means that the coating contains less than 1% by weight of pigment, i.e. consists to an extent of at least 99% by weight of the glass flux. A “pigment” means particles that alter the transmission properties of the coating compared to a coating consisting exclusively of glass flux. In particular, such pigment particles can cause coloring of the coating or reduced transmittance of the coating.

An “at least partly fused” glass flux means a glass flux, i.e. a quantity of glass particles with a defined size distribution, in which at least some of the particles have fused and solidified again and therefore no longer take the form of particles in the shape and size originally present in the glass flux. Because of this fused fraction of the particles, the particles of the glass flux are firmly bonded to form a layer. At the same time, the fused portion of the glass particles also serves to form a bond to the substrate. The unfused portion of the glass particles has the effect that the surface is not completely flat, which would be expected in the case of a completely fused glass flux. Instead, the partial fusing of the glass particles results in a defined surface roughness of the coating.

The roughness of the surface of a glass or glass-ceramic product according to the invention, as expressed by the mean square height Sq of the surface, is at least 0.1 μm and at most 2.5 μm. The mean square height of the surface of the coating is calculated here by the following method:

$$Sq = \sqrt{\frac{1}{A} \int {\int }_{A} {z}^{2} ( x , y ) dx dy}$$

where A is the surface of the coating in question and z is the variance of a measurement point at position (x,y) from the mean height of the coating. More preferably, the mean square height Sq of the coating is greater than 0.2 μm, greater than 0.3 μm, greater than 0.4 μm or more preferably greater than 0.5 μm.

A further parameter that describes the character of the coating according to the invention is the core height Sk of the surface of the coating. The core height describes the height of that region within the surface material component of the surface area of the coating which is covered by 100% of the equivalence line of the surface material component. This region is also referred to as the core surface. The surface material component (also referred to as “areal material component”) describes what height range of the surface of the coating is covered by what proportion of the coating material in the region of the surface in question. In effect, the material component of the surface that is above any height within the surface area of the coating is thus assigned to that height. In a graph representation of this curve, the ordinate accordingly gives the height within the surface area of the coating, while the abscissa gives the material proportion in % that is accounted for by the region above this height.

The equivalence line is that secant of the curve of the surface material component with the lowest detectable slope (or the smallest gradient), the points of intersection of which with the curve of the surface material component have a separation of 40% with respect to their abscissa. By extrapolating the equivalence line to abscissa values of 0% and 100%, the corresponding ordinate values can be determined, where the core height is the distance between these ordinate values. Accordingly, a low core height means a very compact and therefore durable coating, since a large portion of the surface material is concentrated in a narrow region. The core height Sk of the coating may in particular also be 1.5 μm to 9 μm, 1.5 μm to 8 μm, 1.5 μm to 7 μm, 2 μm to 6 μm or more preferably 2 μm to 5 μm.

It becomes clear from joint viewing of the values for the coating according to the invention with respect to mean square height and core height that the coating according to the invention has a combination of a comparatively rough or matt surface on the one hand with very compact character of the coating at the same time. Consequently, the coating according to the invention features good properties with regard to avoidance of fingerprints and other soiling with simultaneously high resistance to scratches and wear of the coating. This coating contains exclusively components that are harmless to health and is producible in a simple and inexpensive manner.

The glass particles of the glass flux of the coating may in particular be particles of boron-containing glass. The use of boron-containing glass flux has advantages including thermal shock resistance of the coating, and additionally improves the adhesion of the coating, especially when the substrate is a glass-ceramic. In addition, when a boron-containing glass flux is used, it is possible to bake the coating in the process of ceramizing the substrate, i.e. converting a glass substrate to a glass-ceramic substrate. In this way, it is possible to avoid one step in the production of the product, namely separate baking of the coating (called secondary baking).

The above-described matt appearance of the coating, in one embodiment, is also manifested in that the coating has a gloss value of at most 25, measured at an angle of 60°. In this way too, the formation of visible contamination of the coating, especially in the form of fingerprints, can be avoided. For example, the shinier a surface, the greater the visibility of fingerprints on the surface.

Two important and unique parameters of the coating according to the invention have already been discussed. However, the coating according to the invention also differs to a crucial degree from coatings as known in the prior art with regard to further surface parameters.

For instance, in one embodiment, it is also the case that the coating has a skewness Ssk of >0. The degree of skewness of a surface gives information as to whether the surface can be described more as a surface with grooves or valleys, or more as a surface with peaks. In the case of a surface with skewness >0, i.e. a surface with grooves, the frequency of regions that extend beyond the height mean in the height distribution of the surface is by definition smaller than the proportion of regions below the height mean. Since this case can occur only when the regions below the height average are less common but much more pronounced in height (or depth) than the regions above the height average, this means that the region can be described more by valleys and grooves than by prominent peaks.

In arithmetic terms, skewness can be ascertained by adding up the third powers of all elevation values and dividing them by the third power of the mean square height Sq of the surface area of the coating:

$$Ssk = \frac{1}{S {q}^{3}} [ \frac{1}{A} \int {\int }_{A} {z}^{3} ( x , y ) dx dy ]$$

A skewness >0, i.e. a surface with grooves rather than peaks, has the advantage that grooves are significantly more durable than prominent peaks. For instance, reduction of the depth of a groove in the coating requires removal of much more material than required to reduce a peak. Consequently, surface skewness >0 is associated with a higher robustness of the surface character since the structure of the surface is less significantly attacked, for example, even in the course of abrasive cleaning processes.

In a further embodiment, it is also the case that the surface of the coating has a kurtosis Sku of >3, more preferably >3 and <8. The kurtosis of a surface describes the sharpness of a surface profile and is calculated as follows:

$$Sku = \frac{1}{S {q}^{4}} [ \frac{1}{A} \int {\int }_{A} {z}^{4} ( x , y ) dx dy ]$$

In this case, a kurtosis value of Sku >3 describes a surface which is more jagged than rounded. A surface which is more jagged than rounded in terms of surface structures has the advantage that, for example, actuation of touch-sensitive control elements creates only a relatively small contact surface between the surface of the coating and the operator's finger. In effect, the visibility of fingerprints or the like can be avoided since these are disposed only on the very narrow tips of the surface structures.

In a further embodiment, the coating has a thickness of 2 to 10 μm. The thickness of the coating is chosen so as to ensure sufficient stability of the coating, but at the same time the transmission properties of the substrate are influenced to the minimum possible degree by the coating. In addition, structures disposed below the coating are still readily apparent. The thickness of the coating is preferably at least 3 μm, more preferably at least 4 μm. Furthermore, the thickness of the coating is preferably not more than 9 μm, more preferably not more than 8 μm, most preferably not more than 7 μm.

In a further embodiment, it is also the case here that a pigmented decoration layer is disposed at least in sections between the substrate and the coating. This pigmented decoration layer has preferably been applied directly to the substrate and can be created by inkjet printing or screen printing in particular. When glass or glass-ceramic product is used as a cooking surface, the decoration may, for example, be cooking zone marking. By virtue of the arrangement of the decoration beneath the coating, the decoration is protected from abrasion, for example, as a result of cleaning the glass or glass-ceramic product. At the same time, however, because of the low thickness of the coating and the absence of pigment in the coating, the visibility of the decoration and in particular the edge sharpness thereof is only slightly impaired. In principle, the decoration can also be baked together with the coating, which simplifies the production of the glass or glass-ceramic product.

In this case, in a preferred embodiment, the contour line of the decoration layer disposed beneath the coating has a mean square roughness value Rq of not more than 20 μm, preferably not more than 15 μm, in a perpendicular top view of the decoration through the coating in the direction parallel to the substrate surface. The contour line of the decoration layer describes the progression of the transition between that region of the surface of the substrate which is covered by the decoration layer and that region of the surface of the substrate which is essentially free of the decoration layer. What is meant by “essentially free” is a region in which the thickness of the decoration layer and therefore the color effect of the decoration is at least 10%, but not more than 25%, of the maximum color effect of the decoration. The progression of the contour line is considered here analogously to the progression of the height profile of a surface, such that the parameters known for the description of surface characteristics can be used to describe the progression of the contour line. Accordingly, for the progression of the contour line, the mean square roughness value Rq, inter alia, can be reported, which essentially gives information as to the size of the mean square value of all ordinate values z(x) of the contour line at different points x along a measurement distance of length I. The Rq value is calculated as follows:

$$Rq = \sqrt{\frac{1}{l} {\int }_{0}^{l} {z}^{2} ( x ) d x}$$

The Rq value effectively reflects a contour sharpness of a contour of the decoration when viewed through the structured coating. The smaller the Rq value, the sharper the contours of the decoration. This is particularly advantageous since it is still possible in this way to perceive even very fine decoration elements essentially undistorted even through the structured coating.

In a further preferred embodiment, the glass or glass-ceramic product has a decoration layer which is covered by the coating in a first subregion and not covered by the coating in a second subregion. In this case, the mean square roughness value Rq of the contour line of the decoration layer in the first subregion differs only by at most 10%, preferably at most 5%, from the mean square roughness value Rq of the contour line of the decoration layer in the second subregion.

Alternatively, however, the decoration can also be applied to the coating, which can simplify the production of the glass or glass-ceramic product. For example, the matt coating can be applied over a large area by a screen printing method, and then the glass or glass-ceramic product prepared in this way can be decorated in a further step.

In a further embodiment, the combination of decoration layer and coating has a thickness of not more than 15 μm, preferably not more than 12 μm, more preferably not more than 10 μm.

It has already been stated that the coating has been applied at least over part of the substrate surface. This means that the coating can quite possibly also have recesses, for example in order to create a region in which a display may be disposed. By means of a cutout from the coating, i.e. an area of the surface on which no coating is applied, a visual impression of the display can be improved compared to a full-surface coating. However, in a further embodiment, the coating has been applied to one side of the substrate over the full area, which can simplify the production of the glass or glass-ceramic product.

It has already been stated that the glass flux is preferably boron-containing. In a preferred embodiment, it is also the case that the glass flux has the following composition in % by weight based on oxide:

| | |
|---|---|
| SiO₂ | 75-85 |
| Al₂O₃ | 0.1-5 |
| B₂O₃ | 10-15 |
| Na₂O | 1-5 |
| K₂O | 0.1-1.5 |

A glass flux of this composition is suitable in particular for baking of the coating in the course of ceramization of the substrate, which brings clear benefits with regard to the production of the glass or glass-ceramic product according to the invention. The glass flux used may also consist of a mixture of different types of glass. The mixing of different types of glass makes it possible, for example, to adjust the physical properties of the glass flux to the requirements for production of the coating.

Such an added glass flux may also have a composition that differs from the abovementioned composition. For example, such a glass flux may have the following composition in % by weight based on oxide:

| | |
|---|---|
| SiO₂ | 50-65 |
| B₂O₃ | 14-20 |
| Al₂O₃ | 13-20 |
| Li₂O | 2.0-4.0 |
| MgO | 1.0-2.5 |
| CaO | 1.5-2.5 |
| SrO | 1.5-3.0 |
| ZnO | 1.5-3.0 |
| ZrO₂ | 0.5-1.5. |

In the specific selection of the glass flux or a mixture of different glass fluxes for production of the coating, in principle a multitude of material parameters of the glass flux can affect the properties of the coating produced. For example, it is advantageous for the thermal stability of the coating when the coefficient of thermal expansion of the glass flux and therefore of the coating differs only slightly from the coefficient of thermal expansion of the substrate. The surface characteristics of the coating can also be influenced by choosing a material having a suitable softening point. It is advantageous when the softening point relative to the baking temperature of the coating is chosen such that the particles of the glass flux are only partly fused on baking of the coating in the course of the ceramization of the substrate, so as to result in the desired rough surface texture.

In this case, in a further embodiment, it is also the case that the substrate takes the form of a pane and has a thickness between 2 mm and 6 mm, preferably between 3 mm and 5 mm, more preferably a thickness of 4 mm. A substrate “in the form of a pane” is a substrate having length and width that are at least one order of magnitude greater than its thickness. In particular, the glass or glass-ceramic product may be a hob.

The substrates used may be different materials.

For instance, in one embodiment, the substrate is transparent with a transmittance Tᵥᵢₛ of greater than 80%, preferably greater than 85%, and has a chroma c* of less than 10, in particular less than 8. Chroma c* as defined by the CIELab color system is calculated as

$${c}^{*} = \sqrt{{a}^{* 2} + {b}^{* 2}} .$$

This means that the substrate is effectively transparent and largely color-neutral.

The composition of such a substrate in % by weight based on oxide may be chosen, for example, as follows:

| | |
|---|---|
| SiO₂ | 64-68 |
| Al₂O₃ | 19-23 |
| Li₂O | 3.2-4.2 |
| MgO | 0.2-1.0 |
| Na₂O + K₂O | 0.1-1.5 |
| BaO | 0-1.5 |
| CaO + SrO | 0-1.5 |
| ZnO | 1-2.5 |
| TiO₂ | 1.6-2.5 |
| ZrO₂ | 1.2-2.0 |
| SnO₂ | 0-0.5 |
| Nd₂O₃ | 0.005-0.15 |
| Fe₂O₃ | 0.001-0.03 |

Alternatively, in a further embodiment, the substrate is volume-colored and has transmittance Tᵥᵢₛ of less than 10%. A “volume-colored” substrate means one that is not colored by means of a coating, but contains elements within the material that contribute to coloring of the material themselves. Such volume coloring can be brought about, for example, by elements such as chromium, vanadium or molybdenum, which are mixed into the glass composition. By way of example, such a substrate may have the following composition in % by weight based on oxide:

| | |
|---|---|
| Li₂O | 3.0-4.2 |
| Na₂O + K₂O | 0.2-1.5 |
| MgO | 0-1.5 |
| CaO + SrO + BaO | 0-4 |
| ZnO | 0-2 |
| B₂O₃ | 0-2 |
| Al₂O₃ | 19-23 |
| SiO₂ | 60-69 |
| TiO₂ | 2.5-4 |
| ZrO₂ | 0.5-2 |
| P₂O₅ | 0-3 |
| SnO₂ | 0.1-<0.6 |
| TiO₂ + ZrO₂ + SnO₂ | 3.8-6 |
| V₂O₅ | 0.01-0.06 |
| Fe₂O₃ | 0.03-0.2 |

In a further alternative embodiment, it is also the case that the substrate is translucent with a transmittance Tᵥᵢₛ of 2% to 25% or opaque with a transmittance Tᵥᵢₛ of 0.1% to 2%. In particular, the glass-ceramic may be one having a composition as described above with reference to a transparent substrate, where the substrate may have a high proportion by volume of keatite in the crystal phase. In the case of an opaque substrate, coloring in the CIELab color space may also have L* of 85-97, a* of −1.5-0.5 and b* of −6-0.5. Alternatively, in the case of a translucent substrate, the coloring of the substrate may be configured as follows: L*=72-93, a*=−5.5-0, b*=−7-0.5 with a transmittance of 2% to 10%, or alternatively: L*=60-82, a*=−7.5-−2, b*=−19-−4.5 with a transmittance of 10% to 25%.

In particular, when a glass or glass-ceramic product according to the invention is used as a cooking surface, in a further embodiment, the substrate consists of an LAS glass-ceramic, i.e. a glass-ceramic composed of a lithium aluminium silicate. Such substrates have a very low coefficient of thermal expansion and are very resistant to temperature changes, and so they are of excellent suitability in particular for the thermal requirements of a cooking surface.

In this case, in a further embodiment, it is also the case that the substrate has at least one clearance. In particular, such a clearance may be an opening in the substrate, through which, when the substrate is used as a cooking surface, an extractor (also referred to as downdraft) can be integrated into the cooking surface. The coating on the substrate preferably extends as far as the edges of the clearance, so as to achieve a seamless transition of the coated region into the clearance. Such a clearance in a substrate can be created by a variety of methods, in particular by drilling, milling, waterjet cutting, or the like.

In a further embodiment, it is also the case that a light source disposed at a distance of 0.5 mm beneath the glass or glass-ceramic product with a substrate thickness of 4 mm creates a halo of not more than 1.2, preferably not more than 1.15. Further preferably, a light source disposed at a distance of 1.75 mm beneath the glass or glass-ceramic substrate with a substrate thickness of 4 mm creates a halo of not more than 1.4, preferably not more than 1.3. The distance mentioned refers here to the distance between the top side of the light source and the bottom side of the substrate. A “halo” means a measure of the distortion of perception of a light source on transmission through the substrate and the coating disposed on the substrate.

For this purpose, the intensity profile of the light source recorded by a camera in the absence of the glass or glass-ceramic product is compared with an intensity profile which is recorded through the glass or glass-ceramic product with a defined distance between the light source and the underside of the substrate with the same camera in the same arrangement of the camera and light source. The underside of the substrate is preferably smooth, such that a minimum level of scatter occurs on the underside of the substrate. For evaluation of the scattering characteristics, the half-height widths of the measured intensity profiles with and without substrate above the light source are compared with one another, with calculation of the halo value from the quotient of the half-height width with substrate divided by the half-height width without substrate. With a value of 1, the substrate disposed above the light source with the coating disposed thereon accordingly does not affect the measured intensity distribution. With values greater than 1, however, scattering characteristics of the coated substrate can be detected.

In a further aspect, the invention relates to a method of producing a glass-ceramic product as described above, wherein the method comprises the following steps:
a. providing a substrate made of glass,
b. applying a layer of an ink comprising a glass flux and a print medium to at least part of a surface area of the substrate, preferably with application by screen printing,
c. ceramizing the coated substrate.

In the method, accordingly, a common process step c. both ceramizes the substrate, i.e. converts it from glass to glass-ceramic, and bakes the coating. Consequently, a separate step for baking of the coating can be dispensed with, which distinctly simplifies the production of the glass or glass-ceramic product.

For ceramization of the coated substrate, for example, the procedure may be as follows:
a) heating up from room temperature to 680° C. within 23 minutes,
b) increasing the temperature from 680° C. to 800° C. within 19 minutes,
c) increasing the temperature from 800° C. to 918° C. (maximum temperature) within 24 minutes,
d) maintaining the maximum temperature for 10 minutes,
e) cooling to 800°° C. within 20 minutes,
f) cooling rapidly to room temperature within less than 150 minutes.

Alternatively, the ceramization can be conducted as follows:
a) heating rapidly from room temperature to 740° C. within 20 to 26 minutes, especially 24 minutes,
b) increasing the temperature from 740° C. to 825° C. within 12 to 18 minutes, especially 14 minutes,
c) increasing the temperature from 825° C. to 930° C. (maximum temperature) within 4 to 8 minutes, especially 6 minutes,
d) maintaining the maximum temperature for 4 to 8 minutes, especially 6 minutes,
e) cooling to 800° C. within 8 to 16 minutes, especially within 10 minutes,
f) cooling rapidly to room temperature.

In a further embodiment, the coating is applied by screen printing, using a screen with a screen thickness of 140-31 to 54-64 for the screen printing. In particular, a screen of screen thickness 77-55 has been found to be advantageous. It may also be the case that the screen used has regions in which no glass flux is transferred to the substrate, such that cutouts in the coating can be implemented in a simple way. In particular, it is also possible to use a screen that creates a fine structure in the coating, which means that the degree of surface coverage of the coating, i.e. the ratio of coated to uncoated surface area in the coated region of the substrate, is less than 100%. It is possible here, for example, to create patterns in the coating that further reduce the visibility of scratches or contamination of the surface. In this case, the degree of surface coverage preferably does not fall below a value of 80%.

In a further embodiment, it is also the case that a decoration layer is applied to the substrate before the coating is applied to the substrate, wherein the coating is subsequently applied at least to sections of the decoration layer. The decoration layer can be applied here to the substrate in particular by an inkjet printing method. Alternatively, however, it may also be the case that the decoration layer is applied, i.e. disposed on the coating, after method step b.

It has already been stated that the substrate may also have a clearance, for example for integration of an extractor. Such a clearance is preferably introduced into the substrate before the substrate is coated. In this case, the coating can then be applied to the substrate up to the edge of the clearance, such that the coating is not impaired by the production process for the clearance. However, it is also possible to introduce the clearance into the already coated substrate after ceramization.

In a further aspect, the invention relates to an ink for production of a glass or glass-ceramic product as described above, wherein the ink includes a boron-containing glass flux and a print medium, wherein the glass flux has a grain size of D₁₀ greater than 1 μm and D₉₀ less than 20 μm, preferably D₉₀ less than 15 μm. The print medium is in particular a medium containing dipropylene glycol monomethyl ether as solvent, which is particularly advantageous with regard to its biological compatibility. Alternatively, it is possible to use a print medium based on naphtha as solvent.

The glass flux preferably comprises particles of a borosilicate glass, where the glass preferably has the following composition in % by weight based on oxide:

| | |
|---|---|
| SiO₂ | 75-85 |
| Al₂O₃ | 0.1-5 |
| B₂O₃ | 10-15 |
| Na₂O | 1-5 |
| K₂O | 0.1-1.5 |

In a further embodiment, the ratio of glass flux to print medium in the ink is between 10:15 and 10:5, which has a particularly advantageous effect on the printing properties of the ink.

### BRIEF DESCRIPTION OF THE DRAWINGS

The invention will be described in more detail hereinafter with reference to the figures and without limitation thereto. The same reference symbols denote identical or similar elements.

The figures show:

FIGS. 1a, 1b and 1c: schematic diagrams of different embodiments of an illustrative glass or glass-ceramic product,

FIG. 2: a schematic diagram of an illustrative method of producing an illustrative glass-ceramic product,

FIGS. 3a and 3b: a diagram of a surface profile of a matt surface as a comparative example,

FIG. 4: a histogram of an illustrative grain size distribution of a glass flux for production of a coating,

FIG. 5: a perspective diagram of the surface profile of a coating produced with the glass flux from FIG. 4,

FIG. 6: a diagram of the surface profile along a line within the surface shown in FIG. 5,

FIG. 7: a histogram of a further illustrative grain size distribution of a glass flux for production of a coating,

FIG. 8: a perspective diagram of the surface profile of a coating produced with the glass flux from FIG. 7,

FIG. 9: a diagram of the surface profile along a line within the surface shown in FIG. 8,

FIGS. 10a and 10b and 11a, 11b and 11c: a diagram of a decoration disposed beneath the coating in top view of an illustrative glass-ceramic product and a contour line of the decoration layer derived therefrom,

FIG. 12: an illustrative measurement setup for determination of a halo value.

### DETAILED DESCRIPTION

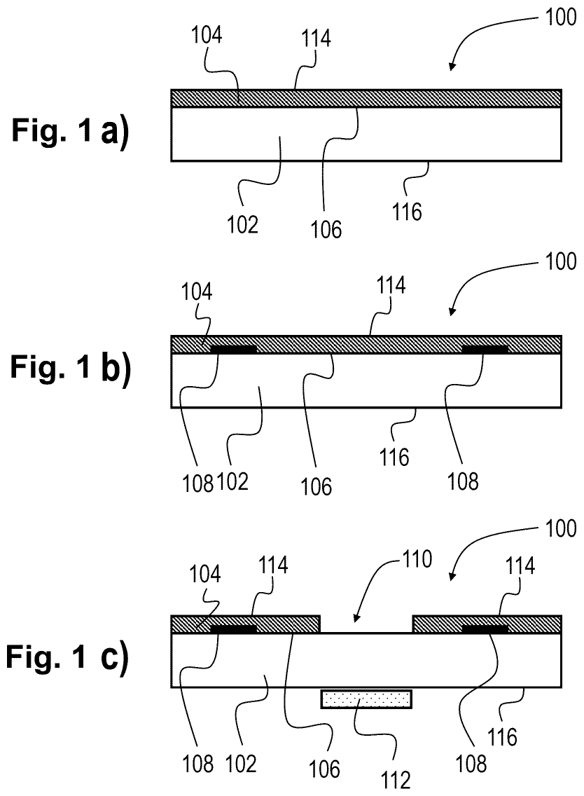

FIGS. 1a, 1b and 1c show schematic diagrams of different embodiments of an illustrative glass or glass-ceramic product 100. In this case, FIG. 1a shows the simplest case in which a coating 104 has been applied directly to a substrate pane 102 of glass or glass-ceramic on a surface 106. The coating has a rough surface 114 with a mean square height Sq in the range of 0.1 μm to 2.5 μm and a core height Sk of the coating 104 from 1.5 μm to 10 μm, as a result of which the coating 104 has a matt appearance. In this case, no further coating is provided at first between the coating 104 and the substrate 102, in particular in the form of a decoration. The substrate 102 is preferably a lithium-aluminium silicate glass-ceramic (LAS glass-ceramic) which is particularly suitable for applications as a cooking surface because of its generally low coefficient of thermal expansion. In this case, the substrate 102 may be a transparent, translucent or opaque material. In addition, the substrate 102 may be essentially colorless or volume-colored.

In the embodiment shown, the coating 104 has been applied to the top side of the substrate 102, which would be facing the user on utilization of the product 100 as a cooking surface and on which, for example, cookware would be placed. Even though no further coating on the underside 116 of the substrate 102 is shown in FIGS. 1a, 1b and 1c, such an additional underside coating is not fundamentally ruled out. Instead, in particular in the case of a transparent substrate 102, the utilization of an underside coating of maximum opacity in addition to the top side coating 104 is advantageous, for example in order to conceal electronic components disposed beneath the substrate 102.

The dimensions of the elements shown in FIGS. 1a, 1b and 1c are significantly exaggerated for reasons of representability and, in particular, are not realistic in relative terms. For example, a preferred thickness for substrate 102 would be 4 mm, while the coating 104 preferably has only a thickness in the range of 2 to 10 μm. It is likewise also the case that the lengthwise extent of the substrate 102 is shown merely as an example and the thickness of the substrate 102 would typically be at least one order of magnitude smaller than its length.

FIG. 1b shows a further embodiment of the glass or glass-ceramic product 100 in which a further coating 108 in the form of a decoration has additionally been applied to the surface 106 of the substrate 102. The decoration 108 is completely covered by the coating 104 in the embodiment shown and therefore protected against outside influences. By virtue of the direct applying of the decoration 108 to the generally very smooth surface 106 of the substrate 102, a high edge sharpness of the decoration 108 can still be guaranteed, while at the same time the rough surface 114 of the coating 104 imparts a matt appearance to the glass or glass-ceramic product 100 overall. The decoration 108 may, for example, be cooking zone markings, manufacturer logos or other markings. In addition to the embodiment shown here, in which the decoration 108 is completely covered by the coating 104, it would also be possible within the scope of the invention that the decoration 108 is only partly covered by the coating 104, i.e. there are areas of the decoration 108 that are exposed.

Although FIGS. 1a and 1b each show the coating 104 as a full-area coating of a surface 106 of the substrate 102, it is also conceivable in principle that the coating 104 extends only over part of the surface 106 of the substrate 102 and there are therefore regions in which the coating 104 has cutouts. This case is shown in FIG. 1c. In the embodiment shown here, which is based on the embodiment of FIG. 1b, the coating 104 in the middle of the diagram has a clearance 110 in which the surface 106 of the substrate 102 is exposed. Such a clearance 110 can be taken into account in particular as early as in the production of the coating 104, in that the corresponding region is left clear on printing of the coating 104 onto the surface 106 of the substrate 102, for example by means of corresponding masking of the substrate 102 or by means of a corresponding design of a screen for applying the coating 104 by means of a screenprinting process.

Such a clearance 110 may be advantageous in particular when display devices 112, for example in the form of seven-segment displays or full-color displays are disposed beneath the substrate 102. Image rendition of such display devices 112 would be distorted in the case of transmission through the coating 104 because of its rough surface. However, this can be avoided by a corresponding clearance in the coating 104.

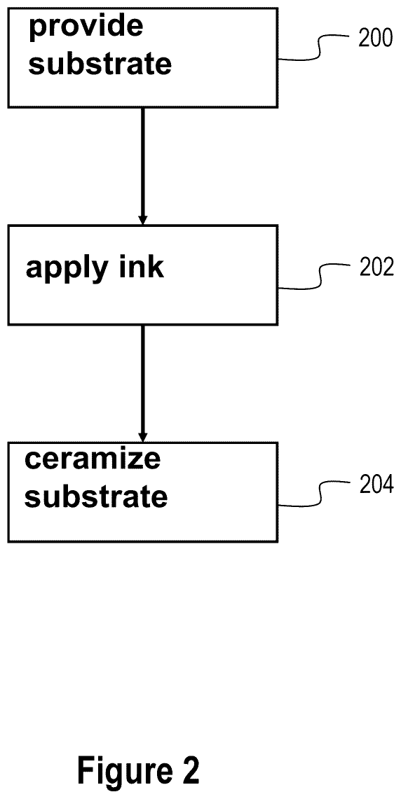

FIG. 2 shows a schematic diagram of an illustrative method of producing an illustrative glass-ceramic product 100. In a first process step 200, a substrate 102 made of glass is provided, which may already have been cut to the desired dimensions for the end product. Further, a pretreatment of the surface 106 of the substrate 102 that is to be coated is also possible here, for example by polishing of the surface 106 in order to establish a flat surface 106 of maximum smoothness.

In a second process step 202, an ink comprising a glass flux and a print medium is then applied to at least part of the surface 106 of the substrate 102. This glass flux preferably has a grain size of D₁₀ greater than 1 μm and D₉₀ less than 20 μm, preferably D₉₀ less than 15 μm. The ink can be applied to the surface 106 of the substrate 102 using any printing methods in principle that are suitable for processing of a glass flux with the specified grain size. Particular preference is given here, however, to applying the ink by means of a screenprinting method. A screenprinting method has the advantage that large-area coatings can be produced with a low level of complexity, while an appropriate design of the screen used can be used to specifically leave cutout regions in the coating 104. In this way, for example, it is possible to create structures as described above with reference to FIG. 1c.

The screen used for screenprinting fundamentally has to be selected according to the print medium used and the glass flux. However, it has been found to be particularly advantageous to use a screen of 140-31 thickness when using a print medium based on naphtha as solvent.

In a third process step 204, the printed substrate 102 is then ceramized. For this purpose, for example, the ceramization program that follows may be used, although this is given solely as an example and should not be regarded as a restriction.
a) heating up from room temperature to 680° C. within 23 minutes,
b) increasing the temperature from 680° C. to 800° C. within 19 minutes,
c) increasing the temperature from 800° C. to 918° C. (maximum temperature) within 24 minutes,
d) maintaining the maximum temperature for 10 minutes,
e) cooling to 800° C. within 20 minutes,
f) cooling rapidly to room temperature within less than 150 minutes.

Alternatively, the ceramization can be conducted as follows:
a) heating rapidly from room temperature to 740° C. within 20 to 26 minutes, especially 24 minutes,
b) increasing the temperature from 740° C. to 825° C. within 12 to 18 minutes, especially 14 minutes,
c) increasing the temperature from 825° C. to 930° C. (maximum temperature) within 4 to 8 minutes, especially 6 minutes,
d) maintaining the maximum temperature for 4 to 8 minutes, especially 6 minutes,
e) cooling to 800° C. within 8 to 16 minutes, especially 10 minutes,
f) cooling rapidly to room temperature.

In the course of ceramization of the substrate 102, a nucleation phase during which crystallization seeds are formed within the substrate 102 is followed by a further increase in temperature to induce controlled crystal growth, which converts the glass substrate 102 to a glass-ceramic with defined mechanical and optical properties. Because of the high temperatures during the ceramization, the glass flux on the surface 106 of the substrate 102 also partly fuses, while the print medium of the ink essentially evaporates without leaving any residue. At the same time, the fused glass flux bonds to the glass substrate 102, giving rise to a very robust coating 104 that is largely resistant to mechanical stress on the surface 106 of the substrate 102. The unfused portion of the glass flux forms an uneven structure on the surface 114 of the coating 104, which brings about the surface parameters according to the invention.

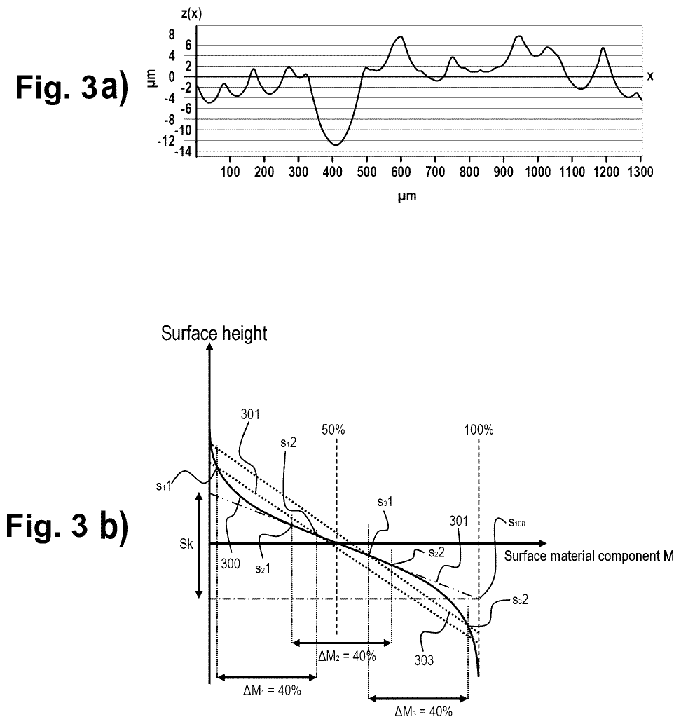

FIG. 3a shows a schematic diagram of the height profile of a surface for elucidation of the surface parameters according to the invention. This shows the height z(x) of the surface across a baseline in μm along a measurement zone within the surface for the different points along the measurement zone (x axis). The baseline is at a height for which the variances of the local elevations of the surface from the baseline along the measurement zone add up to zero. The two-dimensional case shown here is chosen solely for elucidation of the surface parameters already named and described. However, the surface parameters used to describe the subject-matter of the invention are actually not determined along a single line within the surface, but from a consideration of the whole surface, i.e. a three-dimensional representation of the surface.

Starting from the baseline shown in FIG. 3a, the mean square height Sq of the surface is determined by squaring and adding up all local variances z(x) from the baseline, and dividing by the length of the measurement zone. The square root of this result is then taken. This effectively gives a statement as to the extent to which the surface deviates from the baseline on average, i.e. how rough the surface is. The greater this value, the rougher the surface.

The core height Sk is determined by firstly ascertaining the proportion of the surface that is higher than the observed y value for each height y on the ordinate axis. This proportion is then entered as surface material component M on the abscissa axis. For example, in the surface of FIG. 3a), at a height of 8 μm, a value of 0% for the surface material component would be ascertained since the surface does not vary from the baseline over a height of 8 μm. For a height of 6 μm, a low single-digit proportion of the surface that varies by more than +6 μm from the baseline would already be ascertained. By definition, in the diagram shown, the ordinate value 0 μm would be assigned a proportion of 50%, since the baseline exactly splits equal proportions of the surface. In principle, however, a different baseline can also be chosen here as a reference point. For a value of −10 μm, a value of more than 95% would already be ascertained for the surface material component M, while, over and above an ordinate value of about −13 μm, 100% of the surface would be higher than this value.

An illustrative distribution 300 of this type is shown in FIG. 3b. The core height Sk is determined from this distribution by, in a first step, determining the equivalence line of the distribution 300 of the surface material component. For this purpose, a region of the surface material proportion M covered by a surface material proportion ΔM of 40% is shifted along the ordinate axis until that region within which the secant of the end points of the region ΔM with the curve 300 of the distribution of the surface material proportion has the lowest possible slope has been found. This is shown in FIG. 3b by way of example for three different regions with a respective width ΔM of 40%. For the first region ΔM₁, the corresponding points s₁1 and s₁2 are shown, which correspond to the region ΔM₁ on the curve 300 of the surface material proportion. These points of intersection s₁1 and s₁2 give the secant 301 of the curve 300 of the surface material component for the first region ΔM₁. In an analogous manner, the secant 302 for the second region ΔM₂ was ascertained from the points of intersection S₂1 and S₂2, and secant 303 for the third region ΔM₃ from the points of intersection s₃1 and S₃2.

Of the secants 301, 302 and 303 shown, the middle secant 302 has the lowest detectable slope. This secant 302 of the lowest slope ascertained by the method outlined above is also referred to as equivalence line. The core height Sk is determined by extrapolating the equivalence line to surface components of 0% (intersection with the abscissa axis) and 100% (point of intersection S₁₀₀). The points of intersection of the equivalence line with the ordinate values for the area components of 0% and 100% are then used to determine the core height Sk as the distance between these points of intersection along the abscissa axis. A low core height is equivalent to a high material density of the surface, which in turn contributes to high robustness of the surface to mechanical stress. By way of example, the core height Sk of the surface shown in FIG. 3a is 12.7 μm.

Another relevant parameter for description of the surface of the coating is the skewness Ssk of the surface. As already elucidated above, skewness describes whether the surface can be described more as a surface with peaks (positive skewness) or a surface with grooves (negative skewness). This is equivalent to the question of whether the deflections of the surface from the baseline tend to occur more frequently in positive regions or in negative regions. Thus, if there are more positions for which the ordinate value is positive along the measurement zone, skewness Ssk is also positive; if there are more positions along the measurement zone for which the ordinate value is negative, skewness Ssk is also negative. For two surfaces with identical values for the mean square height Sq, the skewness value may be quite different because the deflections above or below the mean surface height value, because of the calculation from the squared surface heights to determine the value Sq, does not take account of the question of the direction of the deflections. By way of example, the surface of FIG. 3a has a skewness Ssk of −0.33, and so tends to be referred to as a surface with grooves.

A comparable statistical view of the surface properties is also enabled by the other surface parameter of kurtosis Sku which is considered here. Kurtosis is calculated from the sum of the fourth powers of the local height of the surface z(x), normalized over the measurement zone and also divided by the mean square height Sq in the fourth power. What is effectively considered here is how frequently a particular value z occurs along the measurement zone, regardless of its sign. For a value Sku=3, the different values for the height of the surface are in normal distribution about the baseline. In the case of an Sku value <3, the surface tends to have a more rounded structure, while a Sku value >3 indicates a more peaked, jagged surface structure. The surface shown in FIG. 3a) has a kurtosis Sku of 2.77, and so has more of a rounded surface structure.

Two working examples hereinafter describe how a coating with the previously described and claimed properties can be produced.

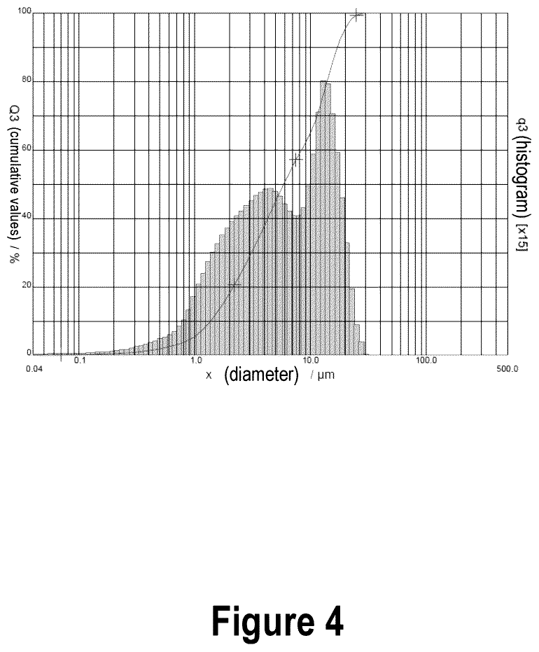

For this purpose, FIG. 4 discloses a histogram of an illustrative grain size distribution of a glass flux for production of a coating. The particles of the glass flux have the following composition in % by weight based on oxide:

| | |
|---|---|
| SiO₂ | 81 |
| B₂O₃ | 13 |
| Al₂O₃ | 2 |
| Na₂O | 3.5 |
| K₂O | 0.5 |

The glass flux is produced by grinding a melted glass according to the above composition, with performance in the present case of wet grinding with water. The glass flux thus produced has a grain size distribution D₁₀ of 1.37 μm, D₉₀ of 17.02 μm and D₉₉ of 24.10 μm.

The glass flux thus produced was then mixed with a screenprinting medium based on dipropylene glycol monomethyl ether (DPM) as solvent at a paste ratio of 10:6 (glass flux to screenprinting medium). The ink thus produced was then applied by screenprinting to a ceramizable glass substrate with a screen of screen thickness 140-31 and baked according to the ceramization program described above.

In addition to the aforementioned glass flux, a further glass flux can be added in order to adapt the properties of the coating to the substrate used. By way of example, a glass flux of the following compositions may be used:

| | |
|---|---|
| SiO₂ | 54.3 |
| B₂O₃ | 16.7 |
| Al₂O₃ | 16.6 |
| Li₂O | 3.1 |
| MgO | 1.7 |
| CaO | 2.0 |
| SrO | 2.3 |
| ZnO | 2.2 |
| ZrO₂ | 1.1. |

Such a glass flux differs from the aforementioned glass flux, for example, in its softening temperature and in its coefficient of thermal expansion, such that mixing of these glass fluxes enables establishment of the mechanical and thermal properties of the coating produced.

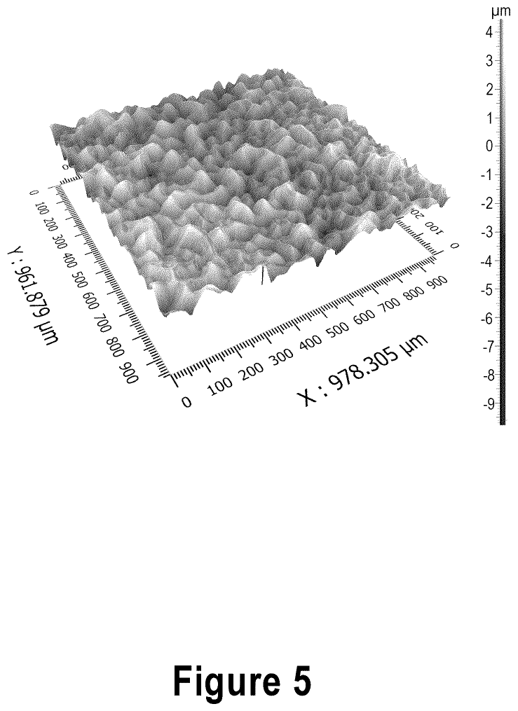

FIG. 5 shows a local section over an area of about 1 mm² from the surface profile of the coating thus obtained in a perspective view. The mean square height Sq of the surface thus obtained is 1.21 μm, the core height Sk is 3.1 μm, the skewness Ssk is 0.01 and the kurtosis Sku is 3.05. In addition, the surface has an arithmetic average height Sa of 0.96 μm.

The arithmetic average height Sa is calculated from the area A of the coating and the height z of the coating by the following method:

$$Sa = \frac{1}{A} \int {\int }_{A} \vert z ( x , y ) \vert dx dy$$

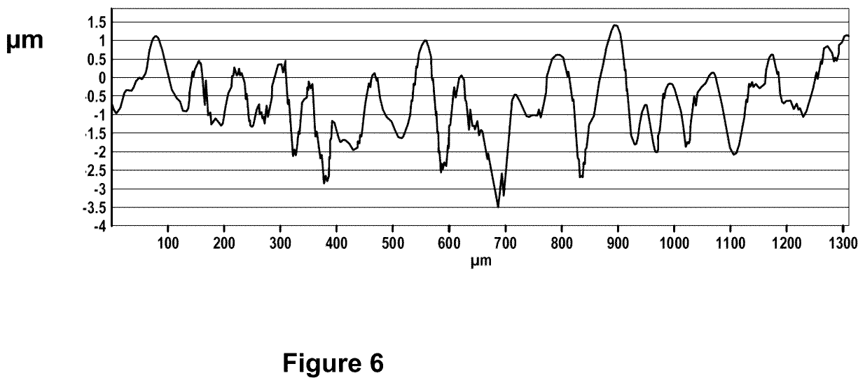

By way of example, FIG. 6 also shows a diagram of the surface profile along a line within the surface shown in FIG. 5.

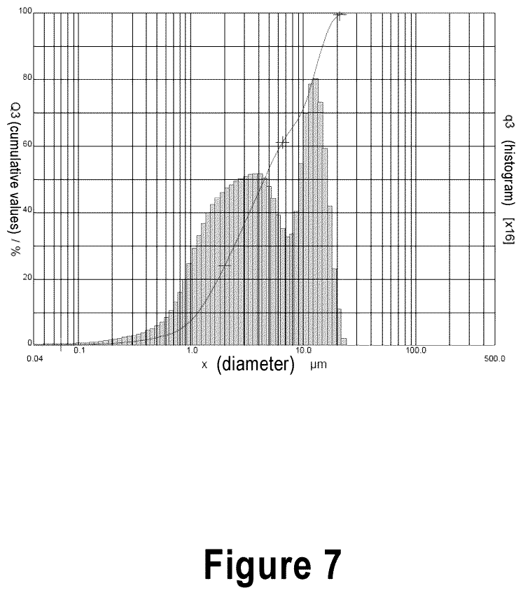

FIG. 7 shows another histogram of an illustrative grain size distribution of a glass flux for production of a coating for an illustrative glass-ceramic product. The glass flux is made of the same material as the glass flux that was described above with reference to FIG. 4. Also in the case of FIG. 7, the glass was ground by wet grinding, which results in the grain size distribution shown. In this case, D₁₀ is 1.15 μm, D₉₀ is 14.72 μm and D₉₉ is 19.89 μm. The glass flux thus obtained was mixed with a naphtha-based screenprinting medium in a paste ratio of 10:12 and applied to the surface of a substrate by means of a screen of thickness 77-55, analogously to the exemplary embodiment of FIG. 4, and baked with the ceramization of the substrate.

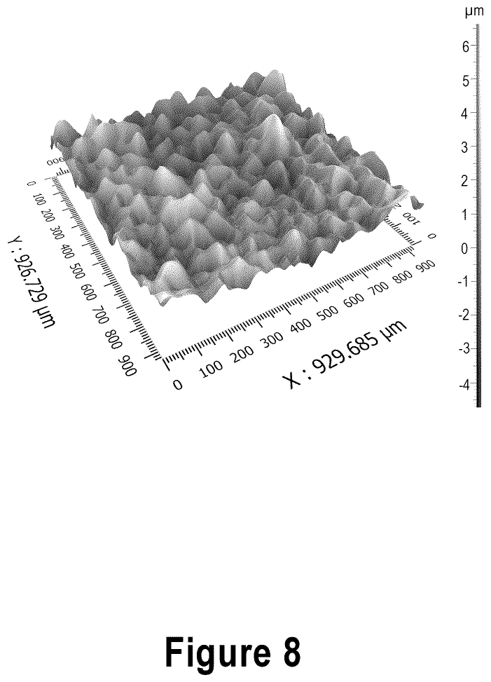

FIG. 8 shows a local section over an area of about 1 mm² from the surface profile of the coating thus obtained in a perspective view. The mean square height Sq of the surface thus obtained is 1.6 μm, the core height Sk is 3.9 μm, the skewness Ssk is 0.045 and the kurtosis Sku is 3.46. In addition, the surface has an arithmetic average height Sa of 1.25 μm.

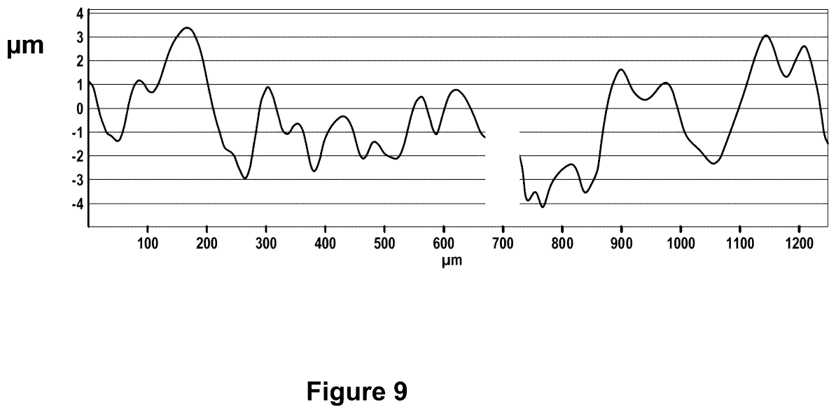

By way of example, FIG. 9 also shows a diagram of the surface profile along a line within the surface shown in FIG. 8.

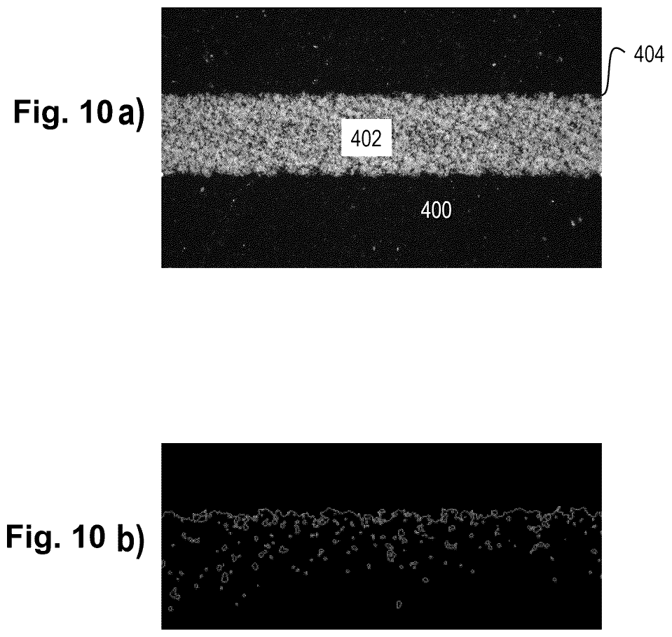

FIGS. 10a and 10b show, in FIG. 10a, a black-and-white image of an illustrative glass-ceramic product with a colored decoration layer beneath the coating. Such an image can be generated, for example, with a light microscope. Because of the granular structure of the coating, the intrinsically largely homogeneous decoration layer and in particular the typically very sharp contour line 404 (shown more clearly in 10b) of the decoration that constitutes the transition between decorated region 402 and undecorated substrate 400 has a washed-out or rough appearance.

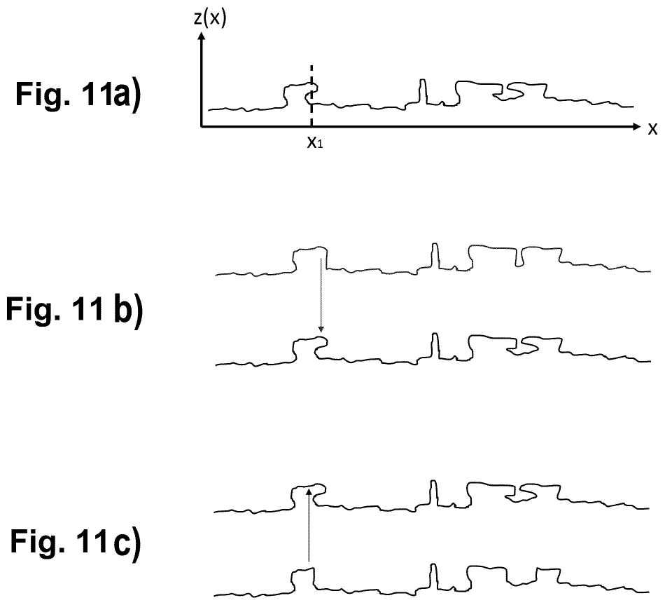

For description of the characteristics of the contour line 404, it is possible by simple means first to extract the specific course of the contour line 404 from the diagram of FIG. 11a. For this purpose, a greyscale value between 0 and 100 can be set as a representative limit for a color effect of the decoration between 0% and 100%, for example the value of 20. All measurement points having greyscale values in the diagram of FIG. 11a above or below the fixed limit are assigned the greyscale value of 0, while all measurement points with a greyscale value of 20 are assigned the value of 100. In addition to a discrete limit, it is also possible to define a range of limits that are to be adopted as a contour line, for example all greyscale values between 15 and 20.

The result of this operation is shown schematically in FIG. 11b for the upper half of the section shown in FIG. 11a. As can be seen in FIG. 11b, the applying of a limit for the greyscale values of the measurement points sometimes has the result that spots within the decoration that are likewise caused by an optical distortion by the structured coating are also interpreted as contour line. It is possible either to manually remove such points from the diagram or to define a range within which the contour line should be viewed such that points outside this range are no longer taken into account.

In this way, a discrete contour line can be ascertained, as shown by way of example in FIG. 11a. Because of the optical distortions by the structured coating disposed above the decoration layer, it may be the case that there are points on the x axis along the contour line, when viewing the contour line in an x-z diagram, for which there are two different points on the z axis that lie on the contour line. In FIG. 11a, this is the case at point x1, for example, since this point cannot be assigned a unique z value that lies on the contour line, since a straight line through point x1 parallel to the z axis intersects the contour line at two points.

However, determination of the mean square of all ordinate values of the contour line requires a curve that assigns only one z(x) value to each x value, and so, in a further step, the curve has to be converted to a correspondingly adapted curve. This can be done either by assigning the highest value z(x) on the contour line to each point x to which several ordinate values z(x) can be assigned. This is illustrated by way of example in FIG. 11b. Conversely, each point x can also be assigned the lowest ordinate value z(x) on the contour line, as shown in FIG. 11c.

The contour lines obtained in this way can then be used to determine the mean square value, equivalent to the mean square roughness value Rq. It is also possible here that the Rq value is determined for each of the two contour lines of FIG. 11b and FIG. 11c, and the mean of these two values is assumed to be the actual value of the contour line. In this way, a statement can be made as to the extent to which an intrinsically sharp contour line of a decoration is distorted by the structured coating deposited on the decoration.

In addition to the above-described Rq value, other parameters for characterization of the progression of the contour line that are known from the analysis of surface characteristics can also be determined. For example, it is also possible to ascertain each of the two-dimensional parameters Sa, Ssk and Sku described above with reference to the characteristics of the surface 114 of the coating 104 of an illustrative glass or glass-ceramic product 100 in one-dimensional form, i.e. Ra, Rsk and Rku for the progression of the contour line. The arithmetic mean roughness value Ra of the contour line preferably is at most 15 μm, while the skewness value Rsk is preferably less than zero. Further preferably, the kurtosis Rku of the contour line is greater than 3.

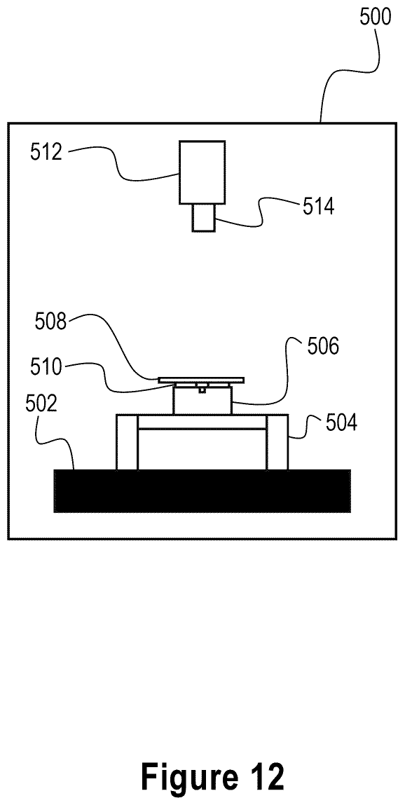

FIG. 12 shows an illustrative measurement setup for determination of the halo value of an illustrative glass or glass-ceramic product 100. In this case, a light source 506 with a lighting means, for example a white seven-segment display, is positioned on a holder 504 disposed in a dark chamber 500 on a vibration-insulating base 502. The article 508 to be examined, in particular a substrate pane, can be placed in turn onto the light source, by means of which a defined distance between the lighting means and the underside of the article 508 can be established by spacers 510 disposed between the article 508 and the light source 506. Above the article 508, a camera 512 with a lens 514 is disposed perpendicularly above the light source 506 or above the lighting means used, and is focused on the surface of the lighting means. The camera 512 may be positioned above the light source 506, for example, at a distance of about 30-35 cm.

The halo value is then determined by conducting a zero measurement in the absence of the article 508 and a measurement with the article 508, recording the image of the lighting means in greyscale each time. The images obtained in this way and in particular the progressions of the intensity distribution that can be ascertained therefrom in a cross-sectional view through the acquired image can then be used to ascertain the halo value as described above.

The surface parameters Sq, Sk, Ssk, Sku and Sa used and described herein are also described by way of example in DIN EN ISO 25178-2:2023-09.

Although the present invention has been described with reference to preferred working examples, it is not limited thereto, and is modifiable in various ways.

### LIST OF REFERENCE NUMERALS

100 glass or glass-ceramic product
102 substrate
104 coating
106 surface of the substrate
108 decoration
110 clearance
112 display device
114 surface of the coating
116 bottom of the substrate
300 distribution of the surface material component
301 secant
302 equivalence line
303 secant
400 undecorated substrate
402 decorated region
404 contour line
500 dark chamber
502 vibration-insulating base
504 holder
506 light source
508 article
510 spacers
512 camera
514 lens

What is claimed is:

1. A glass or glass-ceramic product comprising:
a substrate made of a glass or glass-ceramic having a substrate surface;
a pigment-free coating on at least one side of the substrate over at least a part of the substrate surface, the coating including an at least partly fused glass flux, a coating surface having a mean square height Sq of at least 0.1 μm and at most 2.5 μm, and the coating having a core height Sk of at least 1.0 μm to at most 10 μm.

2. The glass or glass-ceramic product as recited in claim 1 wherein the coating has a gloss value of at most 25 at a viewing angle of 60°.

3. The glass or glass-ceramic product as recited in claim 1 wherein the coating has a skewness Ssk of >0.

4. The glass or glass-ceramic product as recited in claim 1 wherein the coating has a kurtosis Sku of >3.

5. The glass or glass-ceramic product as recited in claim 1 wherein the coating has a thickness of 2 to 10 μm.

6. The glass or glass-ceramic product as recited in claim 1 further comprising a pigmented decoration layer disposed at least in sections between the substrate and the coating.

7. The glass or glass-ceramic product as recited in claim 6 wherein a contour line of the decoration layer disposed beneath the coating has a mean square roughness value Rq of not more than 20 μm in a perpendicular top view of the decoration through the coating in the direction parallel to the substrate surface.

8. The glass or glass-ceramic product as recited in claim 6 wherein a combination of the decoration layer and the coating has a thickness of not more than 15 μm.

9. The glass or glass-ceramic product as recited in claim 1 wherein the coating has been applied to all of the side of the substrate.

10. The glass or glass-ceramic product as recited in claim 1 wherein the glass flux has the following composition in % by weight based on oxide:

| | |
|---|---|
| SiO₂ | 75-85 |
| Al₂O₃ | 0.1-5 |
| B₂O₃ | 10-15 |
| Na₂O | 1-5 |
| K₂O | 0.1-1.5 |

11. The glass or glass-ceramic product as recited in claim 1 wherein the substrate takes the form of a pane and has a thickness between 2 mm and 6 mm.

12. The glass or glass-ceramic product as recited in claim 1 wherein the substrate is transparent with a transmittance Tᵥᵢₛ of greater than 80% and has a chroma c* of less than 10.

13. The glass or glass-ceramic product as recited in claim 1 wherein the substrate is volume-colored and has a transmittance Tᵥᵢₛ of 2% to 10%.

14. The glass or glass-ceramic product as recited in claim 1 wherein the substrate is translucent with a transmittance Tᵥᵢₛ of 2% to 25% or opaque with a transmittance Tᵥᵢₛ of 0.1% to 2%.

15. The glass or glass-ceramic product as recited in claim 1 wherein the substrate consists of an LAS glass-ceramic.

16. The glass or glass-ceramic product as recited in claim 1 wherein a light source disposed at a distance of 0.5 mm beneath the glass or glass-ceramic product with a substrate thickness of 4 mm creates a halo of not more than 1.2.

17. A method of producing the glass-ceramic product as recited in claim 1, the method comprising the following steps:
a. providing a substrate made of glass;
b. applying a layer of an ink comprising a glass flux and a print medium to the at least part of the substrate surface area; and
c. ceramizing the coated substrate.

18. The method as recited in claim 17 wherein the coating is applied by screen printing, using a screen with a screen thickness of 140-31 to 54-64 for the screen printing.

19. The method as recited in claim 17 further comprising applying a decoration layer to the substrate before the coating is applied to the substrate, wherein the coating is subsequently applied at least to sections of the decoration layer.

20. Ink for production of the glass or glass-ceramic product as recited in claim 1 wherein the ink includes a boron-containing glass flux and a print medium, wherein the glass flux has a grain size of D₁₀ greater than 1 μm and D₉₀ less than 20 μm.

21. The ink as recited in claim 20 wherein the ratio of glass flux to print medium in the ink is between 10:15 and 10:5.
